(19) United States
(12) Patent Application Publication
(10) Pub. No.: US 2011/0078948 A1
(43) Pub. Date: Apr. 7, 2011

(54) ASH REMOVAL FROM COAL: PROCESS TO AVOID LARGE QUANTITIES OF HYDROGEN FLUORIDE ON-SITE

(76) Inventors: Chandrashekhar Ganpatrao Sonwane, Philadelphia, PA (US); Sam David Draper, Greenville, SC (US); Eric Stephen Kaufman, Simpsonville, SC (US); Michael David Newkirk, Simpsonville, SC (US)

(21) Appl. No.: 12/571,514

(22) Filed: Oct. 1, 2009

(51) Int. Cl. C10L 5/00; B01J 19/00; B01J 4/00

(52) U.S. Cl. 44/627; 422/119; 422/105; 422/620

(57) ABSTRACT

A method and system for treating coal with hydrogen fluoride to remove fly ash and thereafter regenerating substantially all of the hydrogen fluoride used during the process (thereby significantly reducing the amount of HF on site). An exemplary method includes the steps of charging at least one reaction vessel with coal containing fly ash; feeding hydrogen fluoride into the reaction vessel to form a first reaction mixture of soluble reaction products, insoluble fluoride compounds and initially clean coal; separating out the first soluble and insoluble reaction products; feeding nitric acid into the same reaction vessel to react with any remaining fly ash components and separating out those second reaction products; and regenerating substantially all of the hydrogen fluoride used in the first fluoride reaction.

The present invention relates to the treatment of coal containing fly ash as a commercial fuel and, in particular, to a novel process for treating coal without the accumulation of hydrogen fluoride on-site as the coal cleaning process is being carried out.

### BACKGROUND OF THE INVENTION

The commercial use of untreated coal as a fuel source, particularly coal containing sulfur and fly ash, has long been known to result in potentially unacceptable levels of air pollution, as well as increased maintenance costs for industrial plants relying on coal as a primary hydrocarbon fuel source. Although progress has been made over the years in increasing the efficiency of coal-fired processes, a significant need still exists to develop cleaner and more efficient coal, particularly for use in combined cycle power generation plants. Because the coal suitable for turbine plants cannot contain more than small amounts of particulate fly ash in order to operate efficiently, numerous research and development programs have been undertaken over the past decade to reduce the fly ash, with most programs focusing on harsh chemical treatments to produce an acceptable low ash coal product.

Typically, prior art methods for removing fly ash involve some form of caustic and/or acid treatment of the coal raw materials in an effort to extract the ash constituents as soluble species. Thereafter, the fly ash components are physically separated and the dissolved ash processed separately from the coal fuel. The known prior art processes for treating fly ash have met with only limited success, particularly caustic treatments that form soluble sodium alumino-silicates or hydrofluoric acid based treatments forming various fluoro-complexes. In addition, larger scale operations invariably require a substantial amount of potentially hazardous chemicals on site to treat the coal feed.

In recent years, the use of hydrogen fluoride (“HF”) to treat raw coal has received increased attention and criticism because of serious environmental, safety, and security concerns over the use of hydrogen fluoride balanced against the desire for cleaner hydrocarbon fuels to use in power generation facilities. In particular, the desire for new coal energy sources has raised concerns over the hazards presented in having large quantities of hydrogen fluoride (particularly at or near the plant site) in a coal cleaning operation. In the past, most coal treatment processes using HF were relatively small in scale or conducted on a batch rather than continuous basis because of strict environmental and/or production permits necessary to comply with industry safety guidelines. The need to produce and handle large quantities of hydrogen fluoride as part of a large-scale process also made the process unduly expensive and commercially unattractive.

The practical problems encountered with large quantities of hydrogen fluoride remaining on-site, particularly for batch processes, can be seen in the following example. For a 600 megawatt (net output) power plant, the existing process requires approximately 16-20 tons of hydrogen fluoride in one or more batch reactors in order to treat 660 tons of coal using a reaction process taking several hours to complete. Although most of the hydrogen fluoride reacts with the fly ash (with the reaction rate decreasing over time), the process still requires approximately 16-20 tons of hydrogen fluoride available at the outset of the process, thereby posing a significant safety and environmental risk due to the highly toxic nature of hydrogen fluoride (which can be fatal if inhaled, or even contacted). Hydrogen fluoride acts as a systemic poison readily absorbed through the skin, and thus even skin contact can be fatal.

In contrast to fluoride in vapor or aqueous form, mineral hydrogen fluoride compounds (such as CaF₂) are almost always solids and significantly less toxic to humans. They are easier to contain in the event of a spill, and less likely to result n a release to the environment. Thus, controlling and maintaining the amount of hydrogen fluoride in the process through the use of mineral fluorides, rather than HF as a raw material, has significant advantages from the standpoint of plant operation and human safety.

Heretofore, known processes for using hydrogen fluoride to treat coal containing fly ash have not been successful in avoiding the accumulation of aqueous or vapor HF on-site to carry out the treatment steps. U.S. Pat. No. 4,169,170 is typical of prior art processes that use concentrated hydrogen fluoride to process raw coal by dissolving and removing ash and sulfur from the raw material coal feed. Although the '170 patent mentions in passing the possibility of purifying and/or recycling hydrogen fluoride, it does not disclose any credible coal treatment process to generate and recycle the necessary amounts of hydrogen fluoride to treat the input coal feed.

A recent laboratory-scale study regarding the use of hydrogen fluoride to produce “ultra clean” coal products conducted by Karen M. Steel and John W. Patrick, entitled “The Production of Ultra Clean Coal by Sequential Leaching with HF Followed by HNO₃,” published in Fuel 82 (2003) 1917-1920 (referred to as the “University of Nottingham process”), has demonstrated some success in treating fly ash using hydrogen fluoride on a relatively small bench scale. However, the University of Nottingham process suffers from the same basic problem encountered in other batch processes that rely on hydrogen fluoride as a main reactant, namely the presence of unacceptable quantities of HF on-site to carry out the reaction with fly ash, again raising safety and environmental concerns.

Another known prior art process developed by Kinneret Enterprises, Ltd. uses hydrogen fluoride in gaseous form in contact with the raw coal feed whereby the unreacted hydrogen fluoride gas is separated and recycled. An aqueous solution of 20-30% hydrogen fluoride is used to leach the formed fluoride minerals away from the coal with hydrogen fluoride gas recovered from the solution at elevated temperatures and pressures. Although the Kinneret process has met with some success, it still suffers from the same basic deficiency of requiring substantial amounts of unreacted hydrogen fluoride as the batch process is being carried out.

Other known prior art processes encounter similar process control issues with excess hydrogen fluoride on-site. For example, U.S. Pat. No. 4,083,940 to Das discloses the use of a 0.5-10% hydrofluoric acid solution in combination with an oxidizing agent such as nitric acid to purify coal to “electrode purity” (low ash content). Similarly, U.S. Pat. No. 2,808,369 to Hickey describes the treatment of coal with fluoride salts using hydrogen fluoride gas after first heating the coal to effect a partial devolatilization. Neither process provides a solution to the problem of excess hydrogen fluoride being continuously required as a necessary raw material to treat low ash coal feed.

### BRIEF DESCRIPTION OF THE INVENTION

The present invention provides a new method and system for treating coal with hydrogen fluoride and nitric acid to remove fly ash components while regenerating substantially all of the hydrogen fluoride used during the process (thereby avoiding any need to maintain significant quantities of HF at the plant site).

An exemplary method according to the invention includes the following basic steps: (1) charging at least one reaction vessel with coal containing fly ash; (2) feeding hydrogen fluoride and water into the reaction vessel to react with the fly ash to form a first reaction mixture of soluble reaction products, insoluble fluoride compounds and initially clean coal; (3) separating the soluble reaction products and insoluble fluoride compounds in the first reaction mixture (typically sludge-like in form) from the initially clean coal; (4) feeding nitric acid into the reaction vessel in an amount sufficient to react with any fly ash components remaining in the initially clean coal to form a second reaction mixture comprising additional soluble reaction products, insoluble nitrate compounds and an “ultra clean” coal; (5) separating out the additional soluble reaction products and insoluble nitrate compounds from the ultra clean coal; and (6) regenerating substantially all of the hydrogen fluoride used in the method from the fluoride compounds formed in the first reaction mixture for use in an essentially closed process.

An exemplary method according to the invention also includes steps to regenerate substantially all of the nitric acid used to form the nitrate compounds present in the second reaction mixture. A related system and components for treating coal containing fly ash includes the optional use of multiple reaction vessels operating in series to allow for an essentially continuous coal treatment operation, again without requiring significant quantities of hydrogen fluoride to remain on site during the process.

### BRIEF DESCRIPTION OF THE DRAWINGS

FIG. 1 is block flow diagram of a prior art bench scale process that uses hydrogen fluoride to remove fly ash present in a coal feed and regenerate some of the hydrogen fluoride using pyrohydrolysis;

FIG. 2 is a simplified process flow diagram depicting the major pieces of equipment and process streams used in a conventional batch process relying on relative large quantities of hydrogen fluoride stored on site as a primary reaction component;

FIG. 3 is a process flow diagram showing the major pieces of equipment and process streams for an exemplary semi-batch process according to the invention for reducing the fly ash in a coal feed while effectively eliminating the need for additional hydrogen fluoride (or hydrofluoric acid) to be maintained on site as the process is carried out;

FIG. 4 is a process flow diagram of an alternative process according to the invention that utilizes hydrogen fluoride and multiple reaction vessels to remove fly ash by employing a combination of batch and continuous operations and controlled syntheses to regenerate hydrogen fluoride used in the process; and

FIG. 5 is further alternative embodiment of an exemplary process according to the invention using a controlled synthesis of hydrogen fluoride in a semi-batch process that again eliminates the need to provide additional on-site hydrogen fluoride.

### DETAILED DESCRIPTION OF THE INVENTION

As noted above, the present invention provides a unique continuous and/or semi-batch process for cleaning coal containing fly ash that avoids the problems encountered in the prior art resulting from the formation, use and storage of large quantities of hydrogen fluoride and/or the by-products of hydrogen fluoride reactions. In exemplary embodiments, the process reduces the need for on-site hydrogen fluoride by at least 90-95% as compared to conventional coal cleaning techniques. The process does employ hydrofluoric acid and nitrates (NO₃ compounds) as reactants to clean the coal and remove fly ash constituents. However, unlike prior art systems, the process modifications described below virtually eliminate the need to have excess hydrogen fluoride (in either gas or liquid form as aqueous hydrofluoric acid) available to complete the coal cleaning operation.

By way of summary, an exemplary process introduces hydrogen fluoride into a coal reactor under very precise, controlled conditions using a sensor/control valve system to ensure that any excess amount of hydrogen fluoride in the coal reactor remains at an acceptable level, for example below about 0.5 tons at any given time for a process involving the treatment of about 600-700 tons of fly ash coal product. One or more sensing elements present in the initial (main) coal/hydrogen fluoride reactor continuously detect and monitor the concentration of unreacted hydrogen fluoride over time, thereby providing a continuous, but changing, input signal that can be used to control the amount of recycled mineral fluorides formed during the initial reaction of hydrogen fluoride with coal containing fly ash.

The invention also includes means for monitoring and controlling the flow of air and/or steam to the system in order to control the temperature of the main hydrogen fluoride coal reactor (e.g., a hydropyrolizer). The monitoring of key operating conditions can also be used to control the input flow of hydrogen fluoride to the main hydrogen fluoride-coal reactor over time.

The mineral fluorides resulting from the primary coal ash reaction according to the invention (particularly CaF₂), as well as a small feedstock stream comprising make-up fluorides, normally consist of solids at room temperature and thus are significantly less toxic/hazardous as compared to hydrogen fluoride. By controlling the rate or formation of mineral fluorides using air/steam during the initial reaction involving coal and hydrogen fluoride, the quantity of unreacted hydrogen fluoride in the main reactor can be precisely monitored and controlled. The process according to the invention is therefore much safer than processes proposed in the literature and prior art, particularly conventional processes in which the coal reacts with hydrogen fluoride in water in a 3:10 ratio in a batch reactor for extended time periods.

In an exemplary process according to the invention, the flow rate of the air/steam (which can also serve as the carrier gas for hydrogen fluoride) and the temperature and the quantity of the hydrogen fluoride in the main reactor (hydropyrolizer) are key variables to be monitored and controlled in order to adjust the flow of hydrogen fluoride into and out of the hydropyrolizer. As noted above, in one embodiment, a sensor provides a control signal to reduce the input flow of hydrogen fluoride if the quantity of free HF in the reactor goes above about 0.5 tons for a process involving about 600-700 tons of fly ash coal. As a result, it has been found that the quantity of available hydrogen fluoride remains sufficiently high to drive the equilibrium reaction to completion (and remove virtually all fly ash reactants) with no excess HF required on site to accomplish that objective.

The invention also utilizes adaptive control means to feed hydrogen fluoride to the main coal reactor while maintaining the net amount in the reactor at acceptable low levels. Exemplary adaptive control variables include the amount of fluorides detected and present in the system, the flow rate of the air/steam to the main reactor, the operating temperature of the hydropyrolizer and the rate of reaction of fluorides to regenerate hydrogen fluoride. All such variables can be used to reduce the quantity of required, on-site hydrogen fluoride from a nominal 16-20 tons down to less than about 0.5 tons in the above example, thereby significantly reducing the safety and health risks posed by hydrogen fluoride remaining at the plant site.

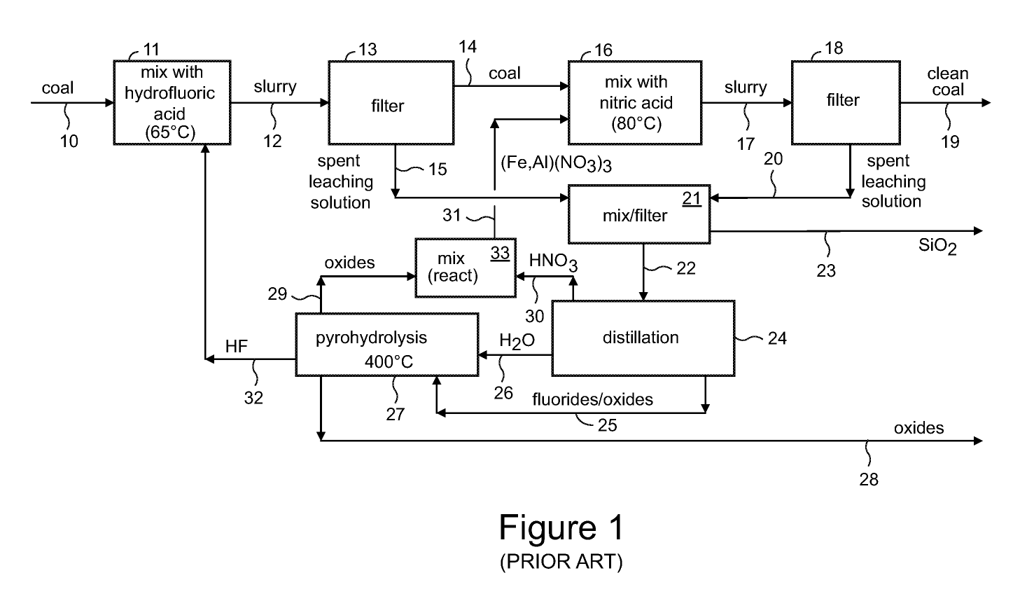

Turning to the formal drawings, FIG. 1 depicts a prior art batch process developed by the University of Nottingham (UK) using hydrogen fluoride to remove fly ash present in a coal feed with a portion of the hydrogen fluoride being regenerated using pyrohydrolysis. In FIG. 1, coal feed 10 containing fly ash is introduced into a mixing/reactor vessel 11 together with hydrofluoric acid. The resulting mixture reacts at a nominal reaction temperature of about 65° C. The mineral matter present in the coal feed (fly ash) reacts with the hydrogen fluoride to form soluble reaction products and trace amounts of insoluble fluorides, such as calcium fluoride. The resulting reaction slurry 12 contains both soluble reaction products and solid “clean” coal with trace amounts of insoluble fluorides. The entire reaction product stream is filtered in a first filter step 13 which separates the initially clean coal 14 from a first spent leaching solution 15.

The initially clean coal 14 undergoes a second reaction/mixing step 16 in which coal 14 and nitric acid are mixed together and maintained at a temperature of about 80° C. The insoluble fluorides and products of the first reaction dissolve in an aluminum and iron nitrate feed 31 containing (Fe,Al) (NO₃)₃ and a residual amount of FeS. The resulting slurry 17 passes through filter 18 to form a second soluble spent leaching solution 20 and “clean” coal 19. The second spent leaching solution 20 from filter 18 in FIG. 1 passes through mixing/filter 21 which treats the combined effluents (first and second spent leaching solutions 15 and 20), resulting in a sludge material 22 and silicon dioxide stream 23.

Sludge 22 in FIG. 1 undergoes a distillation step 24 to remove nitric acid, resulting in a combined fluoride/oxide stream 25, along with regenerated nitric acid 30 and water vapor stream 26. The fluoride/oxide stream 25 and water then undergo a pyrohydrolysis reaction at step 27 to regenerate some of the hydrogen fluoride 32 and produce oxide stream 28. Additional oxides 29 formed during the pyrohydrolysis reaction are blended together in mixing/reaction vessel 33 with a nitrate feed stream 31 which in turn becomes mixed with nitric acid in the second reaction at 16.

As noted above, a threshold problem with the prior art process depicted in FIG. 1 involves the same environmental and safety issue encountered by other batch processes using hydrogen fluoride as a primary reactant. Although the FIG. 1 process has the capability to regenerate a certain amount of hydrogen fluoride, it requires the presence of additional hydrogen fluoride on-site in order to carry out a batch reaction to completion and remove all fly ash in the coal feed. As those skilled in the art appreciate, the effectiveness of this type batch process also depends heavily on the specific type and amount of minerals present in fly ash being fed to the system.

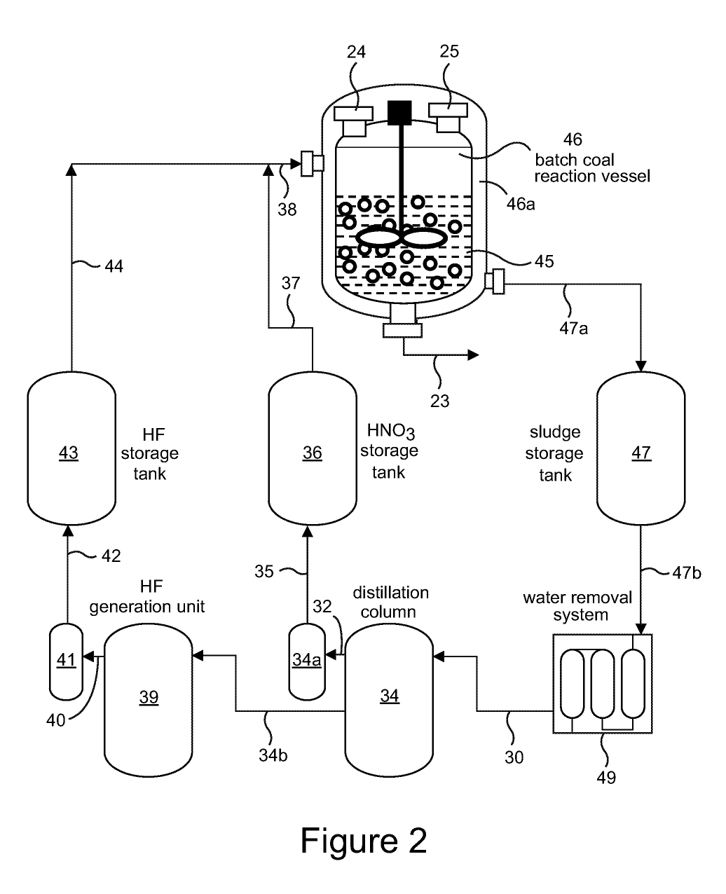

Turning to FIG. 2, a simplified process flow diagram depicts the major pieces of equipment and process streams used in a conventional batch process relying on hydrogen. fluoride as a primary reaction component. FIGURE thus embodies certain of the same disadvantages encountered in other batch processes.

The batch reaction in FIG. 2 includes the following basic steps. A feed comprising coal containing fly ash 45 is fed into a stirred batch coal reaction vessel 46 (typically insulated as shown at 46a), together with a hydrofluoric acid and water solution 44 from hydrofluoric acid storage tank 43. After the initial reaction with the hydrofluoric acid nears completion, the resulting sludge from the reaction is drained into a common sludge storage tank 47 via sludge line 47a. Thereafter, nitric acid is added to the batch reaction vessel 46 from nitric acid storage tank 36 through HNO₃ feed line 37 to initiate a second batch reaction, resulting in additional sludge being formed in batch reaction vessel 46 that must be removed to common sludge storage tank 47. “Clean” coal can then be removed as shown from batch coal reaction vessel 46.

FIG. 2 also depicts the steps used in earlier batch processes to regenerate at least some of the hydrofluoric acid used in the first batch reaction. Sludge 47b from sludge storage tank 47 feeds into a water removal process depicted generally at 49 in the form of a plurality of separation/filtration units. The de-watered sludge 30 feeds into distillation column 34 with overhead condenser 34a which separates out the nitric acid fed to HNO₃ storage tank 36. Residual solids/liquid stream 34b from distillation column 34 feeds into a hydrofluoric acid regeneration unit 39 with overhead condenser 41 that regenerates a portion of hydrofluoric acid that can then be fed via line 42 into hydrofluoric acid storage tank 43.

Again, the system depicted in FIG. 2 invariably requires large quantities of hydrofluoric acid and nitric acid to remain on site for use in the process. By definition, batch coal treatment processes of this type also require sufficient quantities of both acids to always be available in order to restart the process. Another disadvantage of the FIG. 2 system is that it requires that the coal being treated remain in the primary reaction vessel, together with large amounts of acid reactants, for relatively long periods of time.

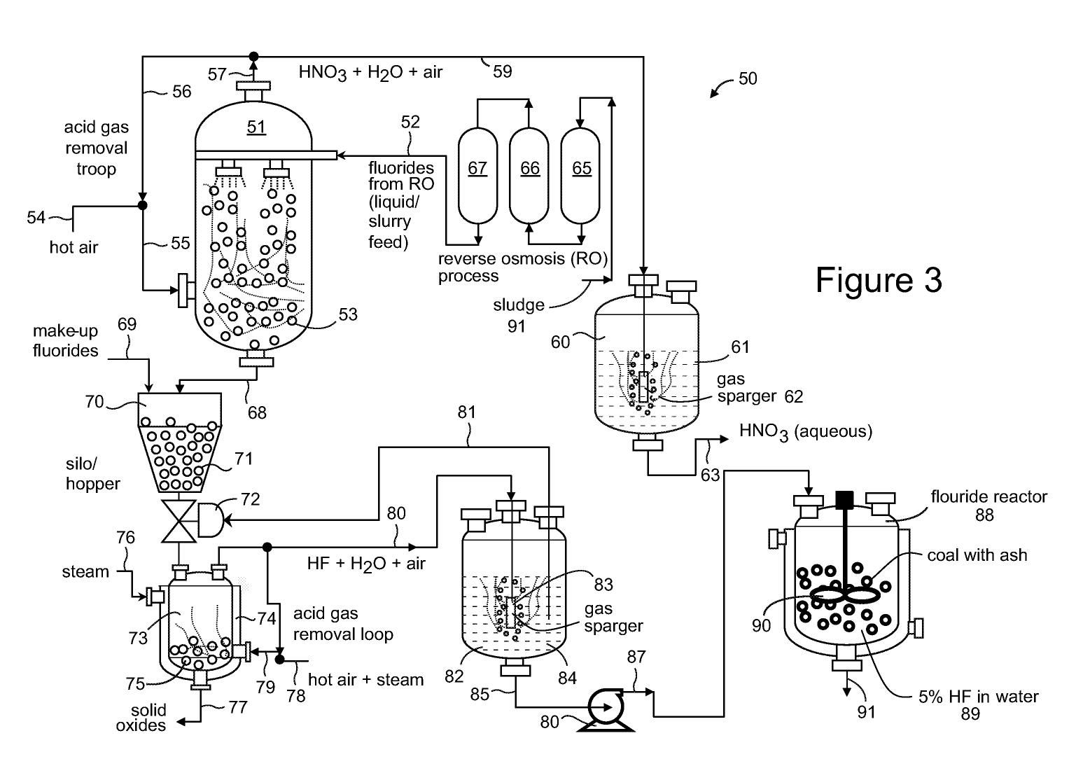

In contrast to the system of FIG. 2, FIG. 3 depicts a process flow diagram of a first exemplary embodiment of the present invention (shown generally as 50) which has the distinct advantage of eliminating the need to maintain large quantities of on-site hydrofluoric acid by effectively regenerating and using virtually all hydrogen fluoride necessary to achieve the desired fly ash removal.

In FIG. 3, a first sludge-like material results from treating fly ash coal as shown in the lower right-hand portion of the figure. Hydrofluoric acid is fed into fluoride reactor 88 through hydrofluoric acid feed line 87 via HF feed pump 80 such that the acid “drips” onto the coal containing fly ash inside fluoride reactor 88. Reactor 88 is agitated as shown at 90. The hydrofluoric acid reacts to form a sludge-like material generally comprising soluble reaction products, insoluble fluoride compounds and “initially clean” coal, i.e., with the majority of oxides in the fly ash removed from the coal feed. Water is also added during the initial reaction resulting in a mixture 89 nominally containing about 5 wt. % hydrofluoric acid with the combined HF and water solution being continuously agitated as shown.

When the initial reaction in fluoride reactor 88 nears completion (nominally after about three hours), the resulting sludge is transported via sludge stream 91 to a sludge holding tank (not shown) to be combined with the sludge resulting from a second reaction of the initially clean coal with nitric acid. The combined sludge stream passes through a reverse osmosis station to remove water using a plurality of separation/filtration units 65, and 67 shown operating in series. The resulting liquid/slurry sludge 52 (containing fluorides with a substantial fraction of water removed) feeds into nitric acid regeneration unit 51 which, in exemplary form, includes a distillation column. Nitric acid and water vapor (steam) are removed off the top of nitric acid regeneration unit 51 (along with small amounts of air) as shown in HNO₁ regeneration stream 59. HNO₃ regeneration stream 59 then feeds into water bath treatment tank 60 and bubbled through a water solution 61 using gas sparger 62 to remove steam and air. The resulting aqueous nitric acid solution 63 can be used for the second reaction with initially-treated coal as described above.

The sludge-like material discharged from the bottom of nitric acid regeneration unit 51 in bottoms stream 68 includes solid particles containing fluoride compounds which pass into silo/hopper 70, with the solids materials depicted at 71. At that point, a small amount of make-up fluorides can be added to the bottoms stream (see make-up stream 69) and the entire mixture fed into hydrogen fluoride regeneration unit 73 insulated as shown at 74, with the solids feed being controlled using motor control valve 72. The hydrogen fluoride acid gas removal loop also includes a combined hot air and steam stream 78 fed into HF regeneration unit 73 through line 79. The hot air and steam react with solids 75 to produce hydrofluoric acid, water vapor and air. All three reaction products leave the regeneration loop via hydrofluoric acid line 80 as feed to water removal tank 82. The solid oxides are removed from HF regeneration unit 73 through solid oxides line 77. Water-removal tank 82 removes excess water vapor and air in mixed solution 84, leaving relatively concentrated hydrofluoric acid 85 fed to circulation pump 80. Pump 80 in turn discharges the acid stream as shown at 87 for use in the fluoride reactor in the manner described above.

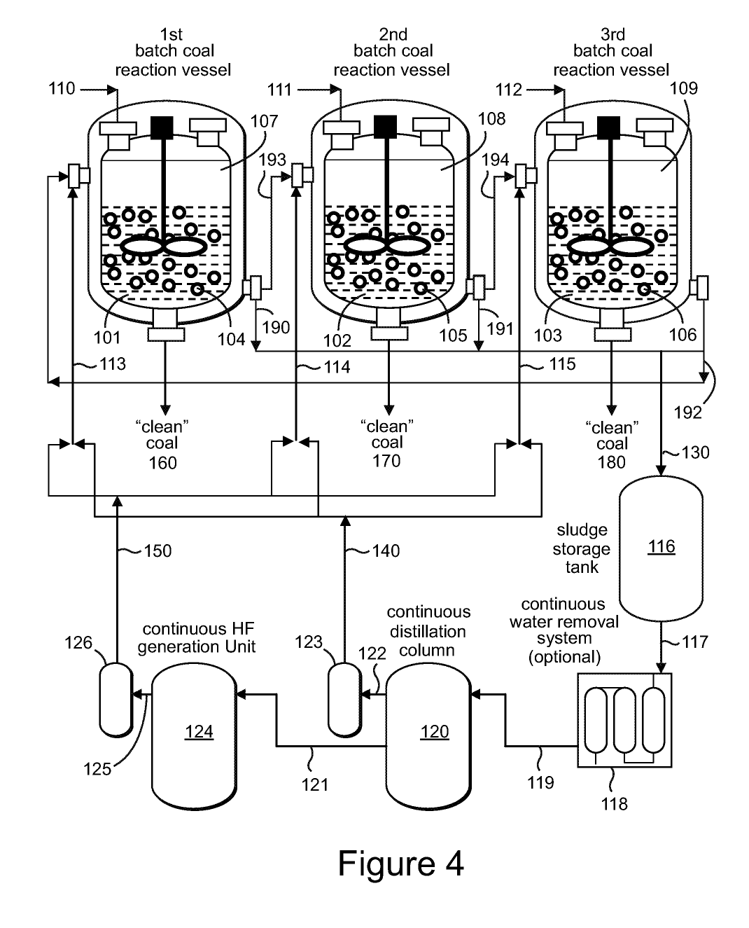

FIG. 4 depicts another exemplary process flow diagram of an alternative embodiment of the process according to the invention, this time employing multiple reaction vessels. In contrast to FIG. 3, the process of FIG. 4 employs hydrogen fluoride to remove fly ash in a coal feed using a combination of batch and continuous operations. The embodiment of FIG. 4 also incorporates the controlled syntheses described above to regenerate hydrogen fluoride and eliminate any need to maintain excess hydrogen fluoride on-site.

The “batch” aspect of the embodiment of FIG. 4 involves three different coal reaction vessels operating in series, with each vessel capable of performing different batch-like operations in sequence, namely (1) reacting the initial coal feed containing fly ash with hydrogen fluoride to form a first sludge material in a first reaction vessel; (2) reacting the initially treated coal with nitric acid in a second reaction vessel to form a second sludge-like material; (3) emptying “clean” coal from the second reaction vessel after completing the second reaction cycle; and (4) filling a third (empty) reaction vessel with new “dirty” coal containing fly ash, and reacting that coal with the HF sludge solution drained from a pervious batch of coal to consume the remaining HF in the sludge.

In addition, sludge transfer lines 190, 191, 192, 193 and 194 depicted in FIG. 4 allow the sludge from a single HF reactor (which typically includes some excess HF) to be transferred to a second reaction vessel containing fresh coal. For example, any one of the sludge transfer lines 190, 191 or 192 could be used to recycle sludge containing residual hydrogen fluoride back to the first batch coal reaction vessel. In like manner, sludge transfer lines 193 and 194 could be used to transfer sludge containing residual hydrogen fluoride to either the second or third batch coal reaction vessels as shown. The use of sludge transfer lines in this manner serves to ensure the efficient use of hydrogen fluoride in the plant itself.

FIG. 4 thus depicts an embodiment in which three different batch-type reactors operate to perform each of the above steps in sequence such that one reactor is always consuming hydrogen fluoride (creating a first sludge waste product), one reactor is always consuming nitric acid (creating a second sludge waste product), and one reactor is always emptying out the resulting “clean” coal and refilling with new “dirty coal” containing fly ash. As such, FIG. 4 illustrates a significant advantage of the present invention, namely the use of multiple vessels to process the various reactions in series.

With reference to the specific process components in FIG. 4, each of three stirred batch reaction vessels 207, 108 and 109 are capable of processing coal containing fly ash, namely coal feeds 110, 111, and 112, by operating in sequence with respect to the different operations described above. Each of the batch coal reaction vessels normally is insulated as shown to better maintain thermal efficiency and control over the reaction temperature. For purposes of illustration only, the following description of batch reaction vessel 107 as used to treat the coal fly ash feed has been provided, with the understanding that the remaining two or more batch coal reaction vessels operate in sequence and thus are capable of performing the same basic operations.

With reference to batch reaction vessel 107, hydrofluoric acid is fed into the vessel through a first common acid feed line 113 in a manner such that the acid “drips” (trickles) onto coal 104 inside the reaction vessel and reacts to form a sludge material and initially “clean” coal, i.e., with certain of the oxides (fly ash) now removed. In the embodiment of FIG. 4, the hydrofluoric acid is being destroyed (reacting) as it is being created elsewhere in the process, which represents a significant commercial advantage over the prior art processes described above. Water is also added during the initial reaction process with hydrofluoric acid and the resulting aqueous solution 101 continuously agitated as shown. The fresh hydrofluoric acid used in the first reaction feeds into reaction vessel 107 through HF feed line 113. When the initial reaction with HF nears completion (nominally after about three hours), the resulting sludge-like reaction products present in reaction vessel 107 are drained into a common sludge storage tank 116 via common sludge removal line 130.

Once the initial sludge is removed, nitric acid is added to the batch reaction vessel 107, first through nitric acid feed line 140 and thereafter common acid feed line 113 in order to initiate the second batch reaction described above (again lasting about three hours), resulting in additional sludge being formed in batch reaction vessel 107. The sludge created by the second reaction eventually is removed to common sludge storage tank 116, which now contains a mixture of both sludge reaction products. Once the sludge has been removed from reaction vessel 107, “ultra clean” coal can be removed from reaction vessel 107 as shown. In effect, common sludge storage tank 116 allows for a continuous HF and HNO₃ regeneration process as depicted at the bottom of FIG. 4. In that sense, the combination of batch and continuous operations serve to significantly reduce the size requirements of the regeneration and water removal units.

FIG. 4 also depicts the steps used to continuously regenerate the hydrofluoric acid and nitric acid used in the first and second batch reactions. Combined sludge 117 from common sludge storage tank 116 feeds into a water removal process (which can be optional), depicted generally at 118 in the form of a plurality of separation/filtration units operating in series. The de-watered sludge 119 feeds into distillation column 120 with overhead condenser 123 via condenser feed 122 which separates out nitric acid, which in turn feeds into coal reaction vessel 107 via line 140 as described above. In like manner, the residual solids/liquid stream 121 from distillation column 120 feeds into a hydrofluoric acid regeneration (e.g., distillation) unit 124 via feed line 125 using overhead condenser 126 which regenerates hydrofluoric acid fed through line 150 into reaction vessel 107.

Once the two primary reactions with hydrofluoric and nitric acid have been completed and the resulting sludges removed, clean coal can be removed from batch reaction vessel 107 through product outlet line 160. Meanwhile, the same basic reaction sequence is taking place in reaction vessels 108 and 109, which include corresponding feed and outlet lines as described with respect to reaction vessel 107. For example, reaction vessel 108 includes coal feed 111, hydrofluoric acid feed line 114 (also serving as a nitric acid feed line, depending on the reaction taking place), coal 105, water 102 and clean coal discharge 170.

Again, the present invention differs significantly from prior art systems that invariably require large quantities of hydrofluoric acid and nitric acid to remain on site for use in the batch process. Although “make-up” fluorides may be necessary to complete the ash removal process, no additional hydrofluoric acid should be required. As noted above, another disadvantage of the prior art systems is that they require that the coal being treated remain in the primary reaction vessel together with large quantities of the acid reactants for relatively long periods of time.

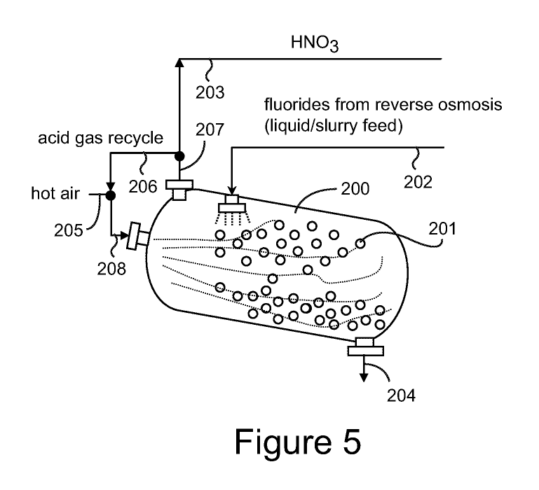

Finally, FIG. 5 depicts a further alternative embodiment of an exemplary process according to the invention using a controlled synthesis of hydrogen fluoride in a semi-batch process in order to eliminate the need for additional on-site hydrogen fluoride. FIG. 5 shows the use of substantially horizontal, as opposed to vertical, nitric acid and hydrofluoric acid regeneration vessels as shown by reaction vessel 200. This alternative embodiment employs the same feed and discharge lines as depicted and described above in connection with FIG. 4, namely acid gas recycle 206, hot air feed 205, nitric acid vapor 207, combined hot air and acid gas recycle line 203, liquid/slurry feed 202 containing fluorides from the reverse osmosis process, solid particulates 201, combined hot air and acid gas recycle feed 208 and liquid/solids (sludge) discharge 204.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A method for treating coal with hydrogen fluoride and nitric acid to remove fly ash components while regenerating substantially all of the hydrogen fluoride used during the treatment, comprising:
charging a reaction vessel with coal containing fly ash;
feeding hydrogen fluoride and water into said reaction vessel in an amount sufficient to react with said fly ash and form a first reaction mixture of soluble reaction products, insoluble fluoride compounds and initially clean coal;
separating said soluble reaction products and said insoluble fluoride compounds in said first reaction mixture from said initially clean coal;
feeding nitric acid into said reaction vessel in an amount sufficient to react with the fly ash remaining in said initially clean coal to form a second reaction mixture of additional soluble reaction products, insoluble nitrate compounds and ultra clean coal;
separating said additional soluble reaction products and insoluble nitrate compounds from said ultra clean coal; and
regenerating substantially all hydrogen fluoride used in said method from fluoride compounds present in said first reaction mixture.

2. A method according to claim 1, further comprising the step of regenerating substantially all nitric acid used in said method from nitrate compounds present in said second reaction mixture.

3. A method according to claim 1, further comprising the step of removing water from said soluble and insoluble reaction products in said first and said reaction mixtures prior to regenerating hydrogen fluoride and nitric acid.

4. A method according to claim 1, wherein said step of regenerating hydrogen fluoride occurs under conditions of pyrohydrolisis of said fluoride compounds in said first reaction mixture.

5. A method according to claim 1, wherein said step of regenerating hydrogen fluoride includes injecting a mixture of air and steam based on the rate of formation of said fluoride compounds during said reaction of fly ash with hydrogen fluoride.

6. A method according to claim 1, wherein said step of regenerating hydrogen fluoride includes monitoring the temperature and concentration of hydrogen fluoride in said first reaction mixture over time and adjusting the flow of hydrogen fluoride into said reaction vessel.

7. A method according to claim 1, wherein said step of feeding hydrogen fluoride includes maintaining the concentration of hydrogen fluoride in said first reaction mixture high enough to drive the reaction with fly ash to completion in forming said fluoride compounds.

8. A method according to claim 1, wherein the amount of hydrogen fluoride regenerated during said method is substantially equal to the amount of hydrogen fluoride used to form said soluble and insoluble fluoride compounds in said first reaction mixture.

9. A method according to claim 1, wherein said coal contains about 0.1 wt. % fly ash.

10. A method according to claim 1, further comprising the step of continuously analyzing the concentration of unreacted hydrogen fluoride present in said first reaction mixture.

11. A system for treating coal containing fly ash with hydrogen fluoride and regenerating the hydrogen fluoride used in said system, comprising:
a reaction vessel sized to receive a prescribed amount of coal containing fly ash;
a first fluid transport mechanism sized to feed aqueous hydrogen fluoride into said reaction vessel in an amount sufficient to react with said fly ash to form a first reaction mixture of soluble reaction products, insoluble fluoride compounds and initially clean coal;
a second fluid transport mechanism sized to feed nitric acid into said reaction vessel in an amount sufficient to react with fly ash remaining in said initially clean coal to form a second reaction mixture of additional soluble reaction products, insoluble nitrate compounds and ultra clean coal;
a discharge line sized to remove said soluble reaction products and said insoluble fluoride and nitrate compounds from said reaction vessel;
a storage tank for holding said first and second reaction mixtures; and
a hydropyrolizer for regenerating substantially all of the hydrogen fluoride fed into said reaction vessel.

12. A system according to claim 11, further comprising valve control means for adjusting the amount of hydrogen fluoride fed to said reaction vessel over time.

13. A system according to claim 11, further comprising one or more sensors to determine the amount of hydrogen fluoride present in said reaction vessel at any given time.

14. A system according to claim 11, wherein said hydropyrolizer provides a control signal to said first fluid transport mechanism to reduce the flow of hydrogen fluoride when the amount of unreacted hydrogen fluoride exceeds a threshold amount.

15. A method for continuously producing ultra clean coal using multiple reaction vessels connected in series and sized to receive and treat coal containing fly ash, comprising:
sequentially charging each of said reaction vessels with coal containing fly ash;
reacting said coal containing fly ash with hydrogen fluoride in each of said reaction vessels to form soluble reaction products, insoluble fluoride compounds and initially clean coal;
separating said soluble reaction products and insoluble fluoride compounds in each of said reaction vessels from said initially clean coal;
reacting fly ash remaining in said initially clean coal in each of said reaction vessels with nitric acid to form additional soluble reaction products, insoluble nitrate compounds and ultra clean coal;
separating said ultra clean coal in each of said reaction vessels from said additional soluble reaction products and insoluble nitrate compounds; and
regenerating substantially all hydrogen fluoride used in said method.

16. A method according to claim 15, further comprising the step of recycling a portion of said soluble reaction products back to one or more of said reaction vessels.
